(19) United States
(12) Patent Application Publication
(10) Pub. No.: US 2005/0152573 A1
(43) Pub. Date: Jul. 14, 2005

(54) Pot type yoke, speaker apparatus and method of manufacturing pot type yoke

(75) Inventor: Tatsuya Suzuki, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/033,268

(22) Filed: Jan. 12, 2005

(30) Foreign Application Priority Data
Jan. 14, 2004 (JP) P2004-007093

(51) Int. Cl. H04R 1/00; H04R 9/06

(52) U.S. Cl. 381/412; 381/433

(57) ABSTRACT

A pot type yoke has a bottom portion, and a wall portion provided upward on the bottom portion. This pot type yoke is provided with a mark for the purpose of distinguishing it from other kinds of the pot type yokes.

### CROSS-REFERENCE TO RELATED APPLICATION

The invention claims priority to Japanese Patent Application No. JP 2004-007093 filed on Jan. 14, 2004. The disclosure of the prior application is incorporated herein by reference in its entirety.

### BACKGROUND OF THE INVENTION

1. Field of the Invention

The present invention relates to a pot type yoke, a speaker apparatus, and a method of manufacturing the pot type yoke.

2. Description of the Related Art

FIG. 1 is a sectional view showing a half of a conventional speaker apparatus 100.

In this speaker apparatus 100, a mounting portion 101d of a pot type yoke 101 is fixed by adhesion to an opening edge 105b of an opening 105a which is formed in a center of a frame 105. The pot type yoke 101 is composed of a bottom portion 101a in a round shape, and an outer peripheral wall 101b in a substantially annular shape which is integrally provided upward from an outer peripheral portion of the bottom portion 101a.

A disk-shaped magnet 102, and a top plate 103 which is also disk-shaped are arranged, in this order, on the bottom portion 101a of the pot type yoke 101, thereby to constitute a magnetic circuit. A voice coil 104 in a cylindrical shape is arranged in a magnetic gap 101c which is formed by the magnet 102 and the top plate 103 with respect to the outer peripheral wall 101b. This voice coil 104 is constructed by including a winding 104a wound around an outer peripheral face of a bobbin 104b. Electric current outputted from an amplifier according to a voice signal flows through the winding 104a of the voice coil 104. The voice coil 104 is actuated by this electric current, and a voice will be issued, when a diaphragm 106 connected to the bobbin 104b vibrates according to the voice signal.

FIG. 2 is a view showing an example of a pot type yoke 101, in which FIG. 2A is a sectional view, FIG. 2B is a bottom view as seen in a direction of an arrow mark A in FIG. 2A. FIG. 3 is a view showing a pot type yoke 111 of another type, in which FIG. 3A is a sectional view, and FIG. 3B is a bottom view as seen in a direction of an arrow mark A in FIG. 3A.

Both the pot type yokes 101 and 111 are of the same size having an outer diameter L1 of the mounting portion and an outer diameter L2 of the outer peripheral wall. On the other hand, an inner diameter of the pot type yoke 101 is L3, while an inner diameter of the pot type yoke 111 is L4 (≠L3). In other words, the pot type yokes 101 and 111 are different from each other only in sizes of their inner diameters, and are the same in other shapes. Specifically, as shown in FIG. 2B and FIG. 3B, the pot type yokes 101 and 111 have the same shape when viewed from the bottom side.

Generally, in designing the speaker apparatus, the magnetic circuit must be designed according to its purpose of use and required characteristics, and different types of the pot type yokes are employed in the respective magnetic circuits.

### SUMMARY OF THE INVENTION

In a production line of a speaker, a number of yokes are stocked, and speakers are successively assembled following steps of the line. However, in case where a plurality of pot type yokes having very similar shapes are used in the same working area, it has been sometimes difficult to discriminate the types of the pot type yokes. For example, in case where outer appearances are very similar to each other as a case with the pot type yokes 101 and 111, as described above, particularly in case where their shapes are exactly the same when looked from the bottom side, it has been necessary to take the trouble to look at them from the top side, in order to find out a difference in their shapes.

Especially, in case of the pot type yokes of the types which have extreme similarity, a difference in size may be on the order of only 1 mm, and it has been necessary to measure the size of the inner diameter one by one, for the purpose of precisely distinguishing one from another. Hence, it has been a lot of troubles to discriminate the pot type yokes.

Under the circumstances, a problem to be solved by the invention is that it is difficult to distinguish a pot type yoke from other similar yokes.

According to an embodiment of the invention, there is provided a pot type yoke including a bottom portion; and a wall portion provided upward on the bottom portion, wherein the pot type yoke is provided with a mark for distinguishing the pot type yoke from other kinds of pot type yokes.

Moreover, there is provided a speaker apparatus including a pot type yoke having a bottom portion and a wall portion provided upward on the bottom portion, wherein the pot type yoke is provided with a mark for distinguishing it from other kinds of pot type yokes.

Further, there is provided a method of manufacturing a pot type yoke including steps of: forging the pot type yoke from a base material, and providing a mark on the pot type yoke.

### BRIEF DESCRIPTION OF THE DRAWING

These and other objects and advantages of this invention will become more fully apparent from the following detailed description taken with the accompanying drawings in which:

FIG. 1 is a sectional view showing a conventional speaker apparatus;

FIG. 2 is a view showing a conventional pot type yoke;

FIG. 3 is a view showing another type of a conventional pot type yoke;

FIG. 4 is a sectional view showing a half of a speaker apparatus in an embodiment according to the invention;

FIG. 5 is an exploded perspective view of the speaker apparatus in the embodiment according to the invention;

FIG. 6 is a view showing a pot type yoke in the embodiment according to the invention; and

FIG. 7 is a schematic view for explaining production steps of the pot type yoke in the embodiment according to the invention.

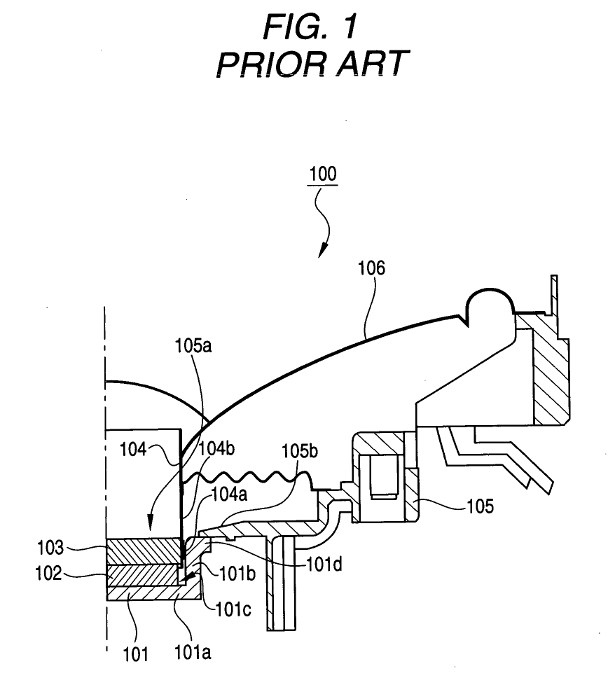

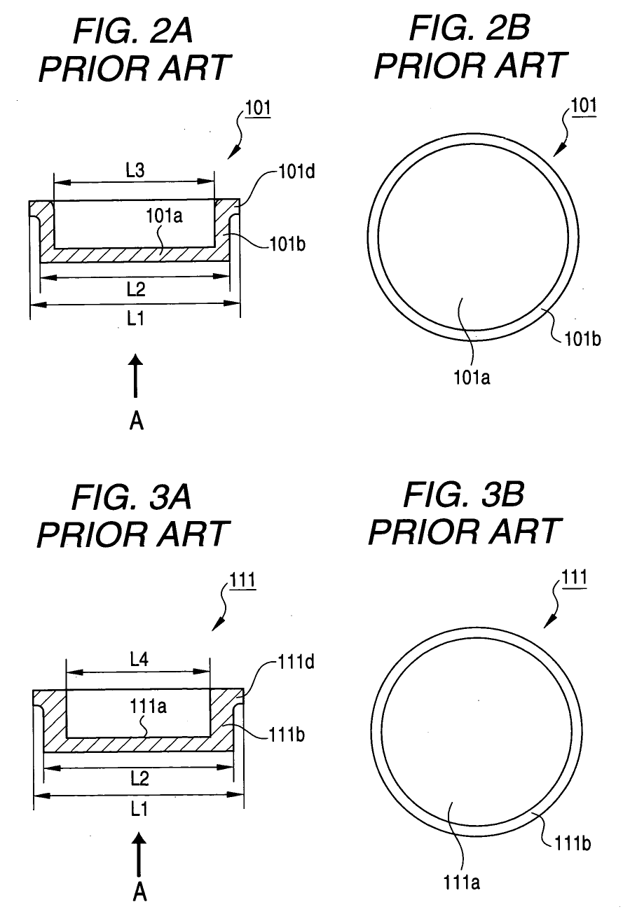

### DETAILED DESCRIPTION OF THE PREFERRED EMBODIMENTS

Now, embodiments of a pot type yoke, a speaker apparatus, and method of manufacturing the pot type yoke according to embodiments of the invention will be described.

The pot type yoke in this embodiment has a bottom portion, and a wall portion provided upward on the bottom portion, and a mark is provided on the pot type yoke for a purpose of distinguishing it from other types of pot type yokes. Accordingly, it will be possible to easily distinguish the pot type yoke from the other types of the pot type yokes by confirming the mark. In this manner, time required for discriminating the pot type yokes can be reduced, and workability in manufacturing the speaker apparatus will be enhanced.

Moreover, in the pot type yoke in this embodiment, the mark is provided on a back face of the bottom portion, and for this reason, it is possible to discriminate types of the pot type yokes by just looking at the back face. Therefore, it is possible to instantaneously judge whether or not the yoke in question is the pot type yoke of desired type, without confirming a size of its inner diameter, even though it has the same outer diameter as the other types of the pot type yokes.

It would be preferable that the mark in this embodiment may be provided on the pot type yokes which have at least the same outer diameter and different inner diameters. By constructing the pot type yokes in this manner, it will be possible to find out a difference in the inner diameters which has been heretofore difficult to judge, and such errors as assembling a wrong yoke to the speaker apparatus can be decreased.

Further, the pot type yoke in this embodiment is formed by forging from a base material with a die, and the mark is provided on the pot type yoke, on either occasion, prior to the forging process, simultaneously with the forging, and after the forging process. From a view point of minimizing the number of the production steps of the pot type yoke as small as possible, it would be preferable to provide the mark simultaneously with the forging, by providing the die with an inscribing die portion for forming the mark.

### Embodiment

Now, an embodiment of the pot type yoke, speaker apparatus, and method of manufacturing the pot type yoke according to the invention will be described in detail, referring to the drawings.

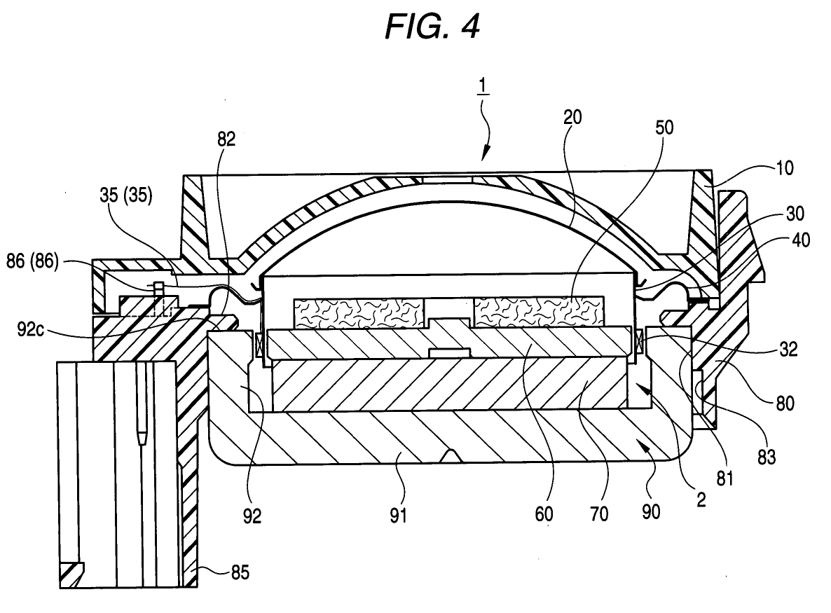

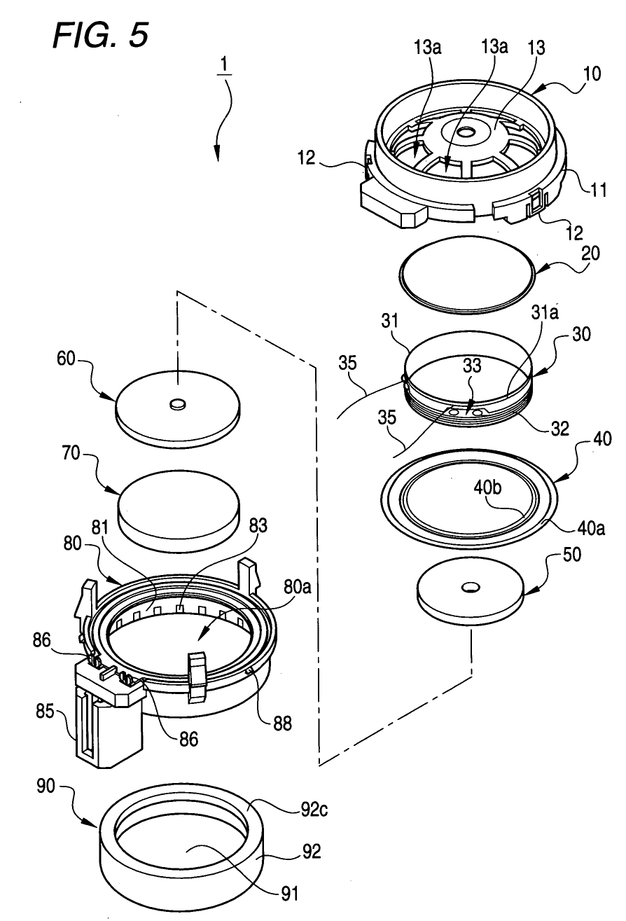

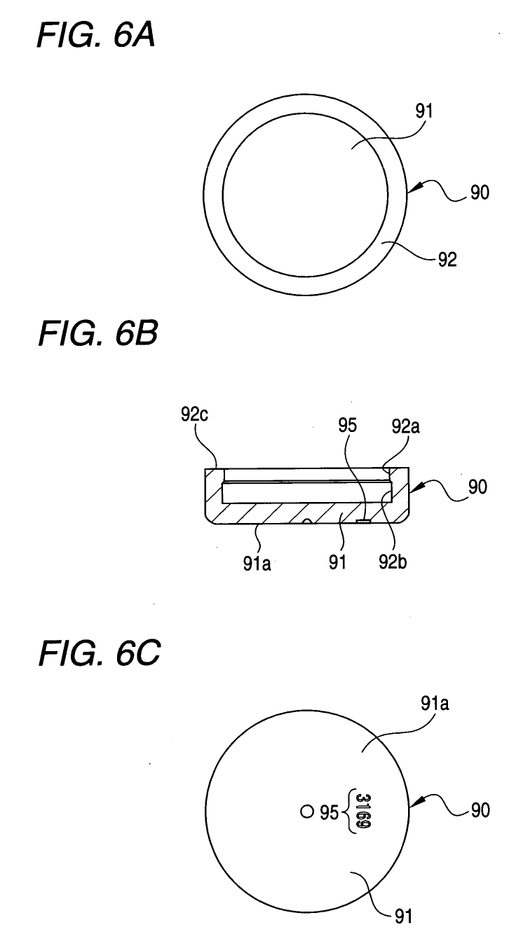

FIG. 4 is a sectional view of a speaker apparatus 1 in this embodiment, and FIG. 5 is an exploded perspective view of the speaker apparatus 1. FIG. 6 is a view showing a pot type yoke 90 in this embodiment, in which FIG. 6A is a plan view, FIG. 6B is a sectional view, and FIG. 6C is a bottom view.

The speaker apparatus 1 in this embodiment is a so-called dome-shaped speaker apparatus and includes, as shown in FIGS. 4 and 5, a cover 10, a diaphragm 20, a voice coil 30, an edge 40, a sound absorbing material 50, a top plate 60, a magnet 70, a frame 80 and the pot type yoke 90.

In the speaker apparatus 1 in this embodiment, the pot type yoke 90 is fixed by adhesion to an inner peripheral face 81 of the frame 80 in an annular shape which is provided with an opening 80a in its center. The magnet 70, the top plate 60, and the sound absorbing material 50 are stacked on this pot type yoke 90 in this order. In the speaker apparatus 1 in this embodiment, the magnetic circuit is configured with the top plate 60, the magnet 70 and the pot type yoke 90.

The pot type yoke 90 is a yoke made of metal and having a bottom portion 91 in a disk-like shape and an annular wall portion 92 upward provided at an outer peripheral edge of the bottom portion 91. An entirety of the pot type yoke 90 has a substantially C-shape in a sectional view. This pot type yoke 90 is formed by forging and cutting a base material, which is metal, hence, the bottom portion 91 and the wall portion 92 are integrally formed with each other. Moreover, as shown in FIG. 6B, a part of an inner peripheral face 92a of the wall portion 92 of the pot type yoke 90 is cut away in a circumferential direction, thereby to form an annular recess 92b.

As shown in FIG. 4, this pot type yoke 90 is positioned with respect to the frame 80 in such a manner that an upper end 92c of the wall portion 92 is in contact with an annular rib 82 which is projected from the inner peripheral face 81 of the frame 80. In this state, an adhesive agent is filled into a plurality of adhesive reservoirs 83 which are formed in a circumferential direction on the inner peripheral face 81, thereby to fix the pot type yoke 90 to the frame 80 by adhesion.

The magnet 70, the top plate 60, and the sound absorbing material 50 are stacked on the bottom portion 91 of this pot type yoke 90 according to this order. The top plate 60 and the magnet 70 both of which are disk-shaped members are fixed keeping a predetermined space from the inner peripheral face 92a of the wall portion 92 of the pot type yoke 90. In this manner, a magnetic gap 2 is formed between the inner peripheral face 92a of the wall portion 92 of the pot type yoke 90, and both the top plate 60 and the magnet 70.

The voice coil 30 is arranged in the magnetic gap 2. The voice coil 30 includes a voice coil bobbin 31 in a cylindrical shape and a winding 32 wound around an outer peripheral face 31a of the voice coil bobbin 31. Two ends of the winding 32 are respectively connected to one ends of lead wires 35 in a connecting portion 33 which is formed on the outer peripheral face 31a of the voice coil bobbin 31. The other ends of the lead wires 35 are connected to terminals 86 provided on a connector portion 85 which is integrally molded with the frame 80. A connecting cable connected to an amplifier, which is not shown, is connected to this connector portion 85. In this manner, electric current output from the amplifier according to a voice signal will flow to the winding 32 by way of the connector portion 85 and the lead wires 35.

An end of the voice coil bobbin 31 in an axial direction is connected to the diaphragm 20. The diaphragm 20 has a dome-like shape, and vibrates in response to actuation of the voice coil 30 by the electric current flowing through the winding 32 of the voice coil 30, thereby to generate sounds.

Moreover, the edge 40 in an annular shape is arranged around the voice coil bobbin 31. The edge 40 has an outer peripheral end 40a fixed to the frame 80, and an inner peripheral portion 40b which holds the voice coil bobbin 31.

The cover 10 is arranged above the diaphragm 20. The cover 10 is formed in a dome-like shape in conformity with the shape of the diaphragm 20. A plurality of engaging pieces 12 formed in a circumferential direction along an outer peripheral wall 11 of the cover 10 are adapted to be engaged with engaging projections 88 formed on the frame 80, whereby the cover 10 is positioned on the frame 80 and fixed thereto. A dome portion 13 of the cover 10 is provided with a plurality of sound emitting holes 13a for emitting the sounds generated from the diaphragm 20, so that the diaphragm 20 may be physically protected from the outside world, and the sound generated from the diaphragm 20 may be appropriately emitted.

In the speaker apparatus 1 in this embodiment, a mark 95 is provided on the back face 91a of the bottom portion 91 of the pot type yoke 90, as shown in FIG. 6C. This mark 95 is provided for the purpose of distinguishing the pot type yoke 90 from other types of the pot type yokes. The same kind of the mark is provided on the pot type yokes 90 of the type which have the same outer diameter, inner diameter, height, particular shape and material. The marks 95 may be of any kind, for example, letters, numerals, symbols, etc. and are not particularly limited, provided that they can be distinguished from one another.

On a production site of the speaker apparatus, there are prepared a plurality of types of the pot type yokes, in some cases. In such cases, it is sometimes difficult to judge whether the pot type yoke in question is correct or not, because the yoke has the same shape as the desired pot type yoke at a glance. However, even under such situation, it would be possible to confirm that the pot type yoke 90 is correct, at a glance, by recognizing the mark 95 provided on the back face 91a of the bottom portion of the pot type yoke 90, in case where it is the pot type yoke 90 as shown in FIG. 6C, for example.

Especially, in case of the pot type yokes, it is difficult to find out a difference of the inner diameters. Therefore, it would be preferable that the marks for discrimination may be provided at least on the pot type yokes which have the same outer diameters and the different inner diameters.

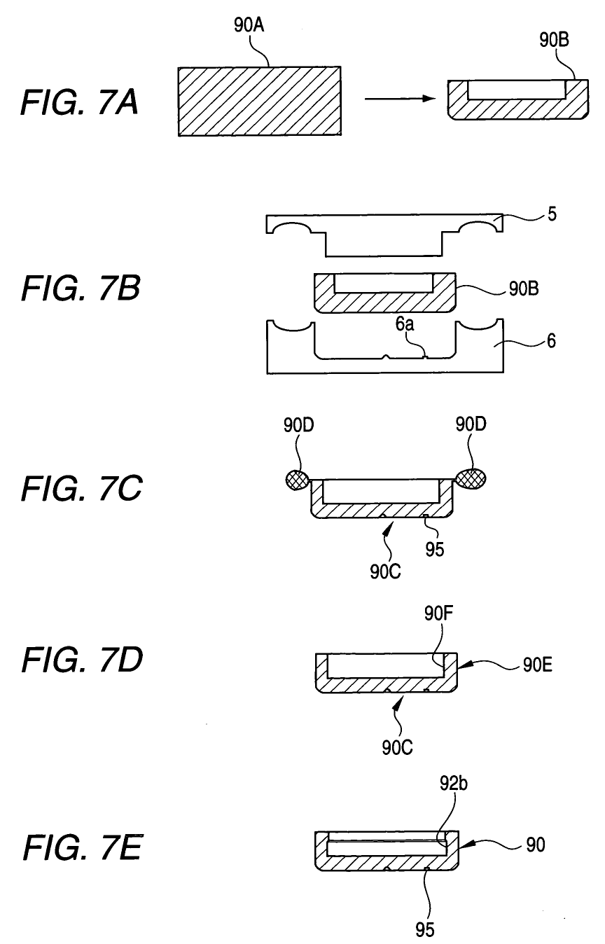

Now, referring to FIG. 7, a method of manufacturing the pot type yoke 90 in this embodiment will be described.

FIG. 7 is a schematic view showing steps for manufacturing the pot type yoke 90.

As a first step, abase material 90A having a predetermined shape is provisionally forged to form a member 90B having a provisional shape corresponding to the shape of the pot type yoke 90, as shown in FIG. 7A. Then, as shown in FIG. 7B, this member 90B is clamped between an upper die 5 and a lower die 6 which have shapes substantially corresponding to a shape of a final product except the annular recess 92b in FIG. 7E, and forged to obtain a primary product 90C as shown in FIG. 7C. On this occasion, the lower die 6 is provided with an inscribing die portion 6a for providing the mark 95, and thus, the mark 95 is provided at the same time with formation of the primary product 90C.

Then, unnecessary portions 90D are removed from the primary product 90C, and a secondary product 90E is formed. Thereafter, a part of an inner peripheral face 90F of the secondary product 90E is cut in a circumferential direction thereby to form the annular recess 92b. Finally, the pot type yoke 90 as shown in FIG. 7E will be obtained by applying a finishing process such as grinding if required.

In the above description, it has been described that the mark 95 is provided by the lower die 6 simultaneously with the forging. However, timing for providing the mark 95 is not limited to such timing, but the base material may be provided with the mark 95 in advance, or the mark 95 may be provided after the final product of the pot type yoke 90 has been formed.

As described herein above, the pot type yoke 90 in this embodiment has the bottom portion 91, and the wall portion 92 provided upward on the bottom portion 91, and the mark 95 is provided in this pot type yoke 90 for the purpose of distinguishing it from other types of the pot type yokes. Accordingly, it will be possible to easily distinguish the pot type yoke 90 from the other types of the pot type yokes by confirming this mark 95. In this manner, the time required for discriminating the pot type yokes can be reduced, and workability in manufacturing the speaker apparatus will be enhanced.

Moreover, in the pot type yoke 90 in this embodiment, the mark 95 is provided on the back face 91a of the bottom portion 91, and for this reason, it is possible to discriminate the types of the pot type yokes by just looking at the back face 91a. Therefore, it is possible to instantaneously judge whether or not the yoke in question is the pot type yoke of the desired type, without confirming the size of its inner diameter, even though it has the same outer diameter as the other types of the pot type yokes.

It would be preferable that the mark 95 in this embodiment may be provided on the pot type yokes which have at least the same outer diameter and different inner diameters. By constructing the pot type yokes in this manner, it will be possible to find out a difference in the inner diameters which has been difficult to judge, and such errors as assembling a wrong yoke to the speaker apparatus can be decreased.

Further, the pot type yoke 90 in this embodiment is formed by forging the base material 90A, and the mark 95 is provided on the pot type yoke 90, on either occasion, prior to the forging process, simultaneously with the forging, and after the forging process. From a view point of minimizing the number of the production steps of the pot type yoke 90 as small as possible, it would be preferable to provide the mark 95 simultaneously with the forging, by providing the lower die 6 with the inscribing die portion 6a for forming the mark, as shown in FIG. 7B.

As described above, it will be possible to discriminate the types of the pot type yokes instantaneously, by providing the marks on the pot type yokes, and at the same time, it will be possible to decrease such accidents that a similar product may be mounted to the speaker apparatus, by mistake.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A pot type yoke comprising:
a bottom portion; and
a wall portion provided upward on the bottom portion, wherein the pot type yoke is provided with a mark for distinguishing the pot type yoke from other kinds of pot type yokes.

2. The pot type yoke according to claim 1, wherein the mark is provided on a back face side of the bottom portion.

3. The pot type yoke according to claim 1, wherein the mark is different from other marks provided on the other kinds of pot type yokes having the same outer diameter as that of the pot type yoke and different inner diameters from that of the pot type yoke.

4. A speaker apparatus comprising:
a pot type yoke having a bottom portion and a wall portion provided upward on the bottom portion,
wherein the pot type yoke is provided with a mark for distinguishing it from other kinds of pot type yokes.

5. A method of manufacturing a pot type yoke comprising steps of:
forging the pot type yoke from a base material, and
providing a mark on the pot type yoke.

6. The method of manufacturing a pot type yoke according to claim 5, wherein the mark is provided simultaneously with the step of forging.
